(19) United States
(12) Patent Application Publication
(10) Pub. No.: US 2024/0380489 A1
(43) Pub. Date: Nov. 14, 2024

(54) CONFIGURABLE CONNECTOR FOR OPTICAL BUS

(71) Applicant: Apple Inc., Cupertino, CA (US)

(72) Inventors: Stefan Meyer, Hoechstadt (DE); Bertram R. Gunzelmann, Koenigsbrunn (DE); Jan K. Ellenbeck, Gruenwald (DE); Zdravko Boos, Munich (DE)

(73) Assignee: Apple Inc., Cupertino, CA (US)

(21) Appl. No.: 18/195,199

(22) Filed: May 9, 2023

(51) Int. Cl. H04B 10/278; H04B 10/2575; H04J 14/02

(52) U.S. Cl. CPC H04B 10/278; H04B 10/2575; H04J 14/0201

(57) ABSTRACT

Circuits, methods, and apparatus that can route signals for wireless communications throughout an electronic device in an efficient manner that can save space, reduce noise, improve coexistence, and be readily assembled. An example can route signals through an electronic device using a bus, ring, or daisy-chain topology. Use of this topology can simplify routing, thereby saving space that can be used for additional functionality for the electronic device, a reduction in size of the electronic device, or both. Fiber-optic segments can be used for signal routing to decrease noise.

### BACKGROUND

The number of types of electronic devices that are commercially available has increased tremendously the past few years and the rate of introduction of new devices shows no signs of abating. Devices, such as tablets, laptops, desktops, all-in-one computers, smart phones, storage devices, wearable devices, portable media players, navigation systems, remote controls, monitors, and others, have become ubiquitous.

These electronic devices often include wireless circuits. These wireless circuits can include receivers, transmitters, antennas, and other components that are compliant with a wireless standard such as Bluetooth, Wi-Fi, millimeter wave, 3G, Long-Term Evolution (LTE), 4G, and other standards. Some or all of these circuits can be repeated at one or more locations in an electronic device. For example, millimeter wave components can be positioned in more than one location to avoid signal blockage that can occur when a user holds or otherwise manipulates the electronic device.

The increasing numbers of wireless standards supported by some electronic devices has led to routing bottlenecks in these electronic devices. Typically, a transceiver can include multiple interface connections, each connected to a set of one or more components for a supported wireless standard in a star topology. This routing can be implemented using coaxial cables or other shielded conductors, leading to the consumption of space inside an electronic device. These conductors, and connections for these conductors, can generate noise that can couple throughout the electronic device. Reflections caused by termination mismatches can generate further noise.

Moreover, routing these coaxial and other conductors can be a difficult assembly process that can reduce yield and waste resources.

Thus, what is needed are circuits, methods, and apparatus that can route signals for wireless communications throughout an electronic device in an efficient manner that can save space, reduce noise, improve coexistence, and be readily assembled.

### SUMMARY

Accordingly, embodiments of the present invention can provide circuits, methods, and apparatus that can route signals for wireless communications throughout an electronic device in an efficient manner that can save space, reduce noise, improve coexistence, and be readily assembled. An illustrative embodiment of the present invention can route signals through an electronic device using a bus, ring, or daisy-chain topology. Use of this topology can simplify routing, thereby saving space that can be used for additional functionality for the electronic device, a reduction in size of the electronic device, or both. As compared to a star topology with conductors emanating from a central location to various points in the electronic device, the ring topology employed by embodiments of the present invention can be considered as a single path looping around the electronic device and having taps at each set of components for a wireless standard supported by the electronic device.

In these and other embodiments of the present invention, signals can be conveyed from an electro-optical transceiver/baseband circuit (referred to here as electro-optical transceiver for simplicity) to the included components for wireless interfaces, and signals can be conveyed from the included components for wireless interfaces to other such components or the electro-optical transceiver using fiber-optic cables. For example, segments of fiber-optic cables can each be used to connect two sets of components for wireless interfaces. A first fiber-optic segment can connect a first set of components to an electro-optical transceiver, a second fiber-optic segment can connect the first set of components to a second set of components, while a third fiber-optic segment can connect the second set of components to a third set of components. This can continue until each set of components are connected in a daisy-chain, or bus or ring topology. The fiber-optic segments can be flexible to simplify assembly and routing throughout the electronic device.

In these and other embodiments of the present invention, the fiber-optic segments can connect to a set of components in various ways. For example, a set of components can include or be associated with a bus connector. The bus connector can have a first optical port to connect to a first fiber-optic segment, and a second optical port to connect to a second fiber-optic segment. The optical ports can include a fiber-optic receptacle, a tethered connection to a fiber-optic segment, or other type of fiber-optic connection. As an example, a bus connector can include a first optical port having a fiber-optic receptacle for accepting a fiber-optic plug and a second optical port having a tethered fiber-optic segment, where the fiber-optic segment terminates in a fiber-optic plug. The fiber-optic plug can be plugged into a fiber-optic receptacle of an adjacent or other bus connector to form a portion of a ring or daisy-chain. This can result in a highly configurable topology where bus connectors and corresponding components can be easily added, removed, or swapped. The bus connectors and corresponding components can be placed around a periphery or elsewhere in an electronic device.

In these and other embodiments of the present invention, each bus connector can connect directly or indirectly to one or more components. The components can include components for wireless circuits such as receivers, transmitters, transceivers, antennas, and other components that are compliant with a wireless standard such as Bluetooth, Wi-Fi, millimeter wave, 3G, Long-Term Evolution (LTE), 4G, and other standards.

In these and other embodiments of the present invention, some of the processing that would typically be performed by an electro-optical transceiver can be moved to some or all of the various bus connectors. This can help to simplify the electro-optical transceiver. This can also provide a system where different sets or configurations of wireless standards can be supported in an electronic device without having to redesign or change the electro-optical transceiver for each configuration.

As an example, an electronic device can support Wi-Fi, Bluetooth, and LTE using a star topology. If millimeter wave communications were added, two or more two sets of components for millimeter wave communications might need to be added to avoid blocking by a user manipulating the electronic device. Each of these sets would require the electro-optical transceiver to include an additional interface and support circuitry. In contrast, embodiments of the present invention can add two or more two sets of components for millimeter wave communications by adding two bus connectors and corresponding fiber-optic segments. Further, when the bus connectors are suitably sophisticated, no change to the electro-optical transceiver might be needed to support millimeter wave communications. Short of this, the bus connectors can include functionality that can simplify electro-optical transceivers and modifications that might need to be made to the electro-optical transceivers.

The fiber-optic segments that are used can be short, on the scale of one-to-several centimeters. As a result, simple, lower-quality fiber-optic cabling can be used, thereby saving resources. Given the wide bandwidth of fiber-optic cables, embodiments of the present invention can support multiple data signals for transmission, multiple received data signals, and multiple control signals. These signals can be analog or digital signals or a combination thereof.

The daisy-chain or ring topology employed by embodiments of the present invention can be modified in various ways. For example, a fiber-optic segment can be split and a connector can be attached to each split of the segment. Other conductors, such as one or more wire conductors for conveying power, control signals, or other power supplies, bias lines, or signals, can be routed adjacent to or along with the fiber-optic cabling. For example, a disable signal that removes power from a blocked (for example by a user's hand) millimeter wave communications circuit and corresponding bus connector can be included.

A bus connector can connect to one or more components for a wireless protocol in various ways. For example, the bus connector can have an electrical connector that can provide and receive analog signals and digital signals. The electrical connector can further provide power to the components. The components can be located inside the electronic device, the components can be external to the electronic device, or some can be located inside while others are located outside. An enclosure for the electronic device can include one or more holes or openings for some or all of the analog signals, digital signals, and power supplies for and from components placed outside. The outside components can be coated or covered with a protective material. The material can be radio-frequency transparent.

In these and other embodiments of the present invention, the bus connectors can include various levels of complexity. For example, a bus connector can include optical add and optical drop circuits. An optical add circuit, or more simply an optical add, can receive a signal from associated components and provide it to a fiber-optic segment that is connected in the direction towards the electro-optical transceiver. The added optical signal can be positioned in the frequency spectrum such that it does not interfere with other optical signals being provided to or from the electro-optical transceiver. An optical drop circuit, or more simply an optical drop, can receive a signal from the electro-optical transceiver over a fiber-optic segment that is connected in the direction away from the electro-optical transceiver. The dropped signal can be removed, that is, demultiplexed and not provided to the following bus connector in the daisy-chain. The dropped signal can be provided to components associated with the bus connector.

In these and other embodiments of the present invention it can be desirable to provide the dropped signal to one or more following bus connectors in the daisy chain. For example, data can be transmitted using more than one bus connector and corresponding components. To provide this, a signal can be dropped by a first bus connector and added back in by the first bus connector to be provided to a second bus connector. When more than one bus connector and transmitter are used, it can be desirable to phase shift the two transmitted signals relative to each other. Accordingly, a bus connector can include one or more delay elements. Delay elements can further be included in an optical path between bus connectors, for example between the first and second bus connector. This can be particularly useful for beam-forming. The delays provided by the delay elements can be set by the electro-optical transceiver, by the bus connector, by multiple bus connectors, by other circuits, or by a combination of some or all of these circuits.

In these and other embodiments of the present invention, it can be desirable to combine two or more received signals. For example, a first bus connector can be used to receive a first signal. A second bus connector can remove the first signal. The second bus connector can receive a second signal and add it to the first signal. The combined signal can be provided as an optical signal over a fiber-optic signal towards the electro-optical transceiver. Instead of combining the first signal and the second signal in the second bus connector, the first signal and the second signal can be provided to the electro-optical transceiver for combining and further processing.

These add, drop, and combine functions can be further extended. For example, optical signal components at multiple frequencies can be dropped from the fiber-optical cabling by a bus connector. Two or more of these multiple frequencies can be combined and forwarded to the electro-optical transceiver or another bus connector. One or more of these various frequencies can be delayed. These delays can be computed by circuitry in one or more bus connectors to further reduce workload on the electro-optical transceiver.

These and other embodiments of the present invention can employ a frequency map that ensures that the frequency of optical signals do not interfere with each other. These maps can be configurable and assigned frequencies can change based on which wireless circuits are active at a given time. The add and drop functions can be used to provide a separation between and among frequencies conveyed over the fiber-optic cabling. The frequency of the optical signals can be set by the electro-optical transceiver, by the bus connector, by multiple bus connectors, by other circuits, or by a combination of some or all of these circuits.

Control signals can be handled in various ways in these and other embodiments of the present invention. For example, control signals can be added and dropped from the fiber-optic cable segments by a bus connector. The control signals can be conveyed on one or more separate wired connections that are routed along with or near the fiber-optic cable segments. Both optical and wired control signals can be used. These control signals can be processed in the bus connector to reduce the workload of the electro-optical transceiver. These control signals can be used in configuring or reconfiguring the bus connectors and associated components, disabling blocked receivers or transmitters, for entering low-power states, and for other purposes. These control signals can be used in allocating various processing tasks among the electro-optical transceiver and circuitry in the bus connectors. The control signals can control the various processing tasks such as protocol translation and pre and post processing of control and measurement data received by the bus connector. The control signals can be used to set an initial state or an updated state. The control signals can be used to set delays in delay elements and to determine the frequencies of the various optical signals.

Some control signals for start-up and other times can be provided using wired conductors. This can allow the configuration of the bus connectors without having to use the optical path. When the optical path is used for configuration, an initial configuration can be set using nonvolatile memory, fuses, or other mechanisms.

A transmitter or receiver can be blocked, for example by a user's hand while holding an electronic device. Corresponding components can be used to detect such a blockage. The corresponding components can send a signal to the electro-optical transceiver to disable the corresponding connector to save power. A control module in the bus connector can also or instead detect blockage. The control module can then turn off the bus connector and inform the electro-optical transceiver. The electro-optical transceiver can turn off some wireless circuits and turn on other wireless circuits in response to a detected blockage. For example, components that are not blocked can be turned on to replace the blocked components.

In these and other embodiments of the present invention, the bus connectors and their associated components can be positioned in the daisy-chain in various ways. For example, bus connectors and components that handle very-high frequency signaling can be positioned closer to the electro-optical transceiver. This can allow the use of lower-speed bus connectors later in the daisy-chain, which can help to conserve resources.

In these and other embodiment of the present invention, unused bus connectors can be included to provide for potential upgrades. An unused bus connector that is not connected to associated components can be optically transparent and can repeat optical signals in each direction without processing.

In these and other embodiments of the present invention, different numbers of daisy-chains and electro-optical transceivers can be used. For example, one electro-optical transceiver can connect to two, three, or more than three daisy-chains.

Embodiments of the present invention can provide routing and bus connectors for wireless interfaces that can be located in various types of devices, such as portable computing devices, tablet computers, desktop computers, laptops, all-in-one computers, wearable computing devices, smart or cell phones, storage devices, portable media players, navigation systems, monitors, power supplies, adapters, remote control devices, chargers, and other devices.

Various embodiments of the present invention can incorporate one or more of these and the other features described herein. A better understanding of the nature and advantages of the present invention can be gained by reference to the following detailed description and the accompanying drawings.

### BRIEF DESCRIPTION OF THE DRAWINGS

FIG. 1 illustrates a bus, ring, or daisy-chain topology for routing signals to wireless circuits according to an embodiment of the present invention;

FIG. 2 illustrates a frequency map according to an embodiment of the present invention;

FIG. 3 illustrates a portion of an electronic device according to an embodiment of the present invention;

FIG. 4 is a block diagram of a bus connector according to an embodiment of the present invention;

FIG. 5 is a block diagram of a bus connector according to an embodiment of the present invention;

FIG. 6 illustrates two bus connectors operating to transmit a signal using two sets of wireless components at different locations in an electronic device;

FIG. 7 illustrates two bus connectors operating to combine two signals received at different locations in an electronic device;

FIG. 8 control signal routing and processing for a bus connector according to an embodiment of the present invention;

FIG. 9 is a block diagram of a bus connector according to an embodiment of the present invention;

FIG. 10 illustrates a transmit path that can be used to transmit signals by a bus connector according to an embodiment of the present invention; and

FIG. 11 illustrates a receive path that can be used to receive signals by a bus connector according to an embodiment of the present invention.

### DESCRIPTION OF EXEMPLARY EMBODIMENTS

Embodiments of the present invention can provide circuits, methods, and apparatus that can route signals for wireless communications throughout an electronic device in an efficient manner that can save space, reduce noise, improve coexistence, and be readily assembled. An example can route signals through an electronic device using a bus, ring, or daisy-chain topology. Use of this topology can simplify routing, thereby saving space that can be used for additional functionality for the electronic device, a reduction in size of the electronic device, or both. As compared to a star topology with conductors emanating from a central location to various points in the electronic device, the daisy-chain topology employed by embodiments of the present invention can be considered as a single path looping around the electronic device and having taps at each set of components for a wireless standard supported by the electronic device.

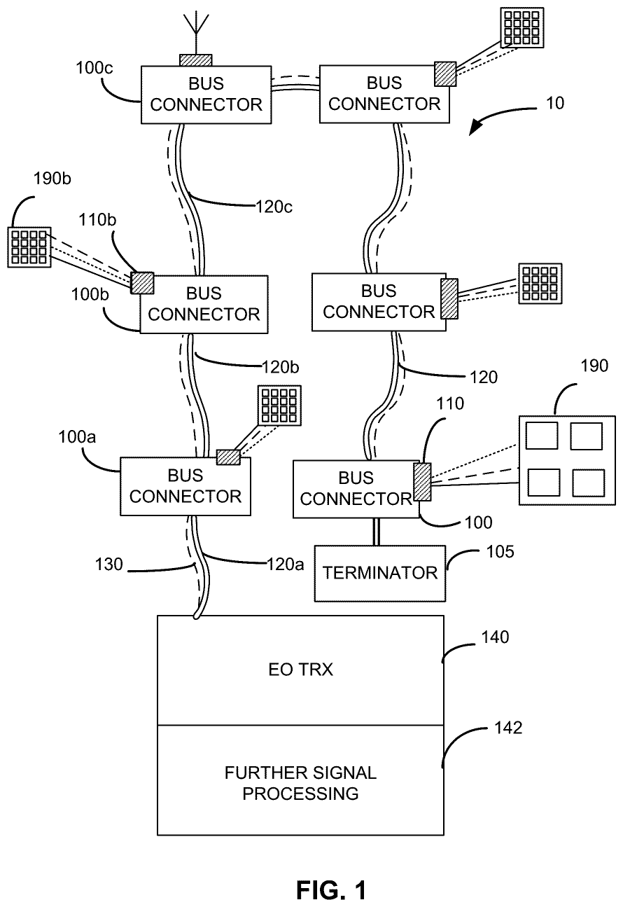

FIG. 1 illustrates a bus, ring, or daisy-chain topology for routing signals to wireless circuits according to an embodiment of the present invention. This figure, as with the other included figures, are shown for illustrative purposes and do not limit either the possible embodiments of the present invention or the claims.

Network 10 can include an electro-optical transceiver 140. Electro-optical transceiver 140 can include baseband circuits, upconverters, downconverters, and other circuits (not shown.) Network 10 can further include a number of bus connectors 100 joined by fiber-optic segments 120, where each bus connector 100 can be coupled to a corresponding set of components 190. That is, each connector can connect directly or indirectly to one or more set of components 190. Each set of components can include components for wireless circuits such as receivers, transmitters, transceivers, antennas, and other components that are compliant with a wireless standard such as Bluetooth, Wi-Fi, millimeter wave, 3G, Long-Term Evolution (LTE), 4G, and other standards.

In this example, a first fiber-optic segment 120a can connect a first bus connector 100a to electro-optical transceiver 140, a second fiber-optic segment 120b can connect the first bus connector 100a to a second bus connector 100b, while a third fiber-optic segment 120c can connect the second bus connector 100b to a third bus connector 100c. This can continue until each set of components are connected in a daisy-chain, or bus or ring topology. The fiber-optic cabling can be flexible to simplify assembly and routing throughout the electronic device.

Signals can be provided by electro-optical transceiver 140 to one or more of the various bus connectors 100 over fiber-optic segments 120. The receiving bus connectors 100 can each provide electrical signals to a corresponding set of components 190 using electrical connector 110. Some or all of the bus connectors 100 can receive electrical signals from the corresponding set of components 190 using electrical connector 110. These signals can be provided by the bus connector 100 back through the network over the fiber-optic segments 120 and other bus connectors 100 to electro-optical transceiver 140. The end of the series of fiber-optic segments 120 can be terminated at terminator 105 to prevent optical reflections. Alternatively, a last one of the bus connectors 100 can be self-terminating, that is, they can provide a termination when a fiber-optic segment is not attached at an optical port.

As an example, a first optical signal conveying data to be transmitted by components 190b can be provided by electro-optical transceiver 140 to first bus connector 100a through first fiber-optic segment 120a. First bus connector 100a can provide the first optical signal to second bus connector 100b via the second fiber-optic segment 120b. The second bus connector 100b can convert the first optical signal to an electrical signal and provide it to components 190b using electrical connector 110b. Components 190b can then transmit the data. Similarly, data can be received by components 190b. This data can be provided to second bus connector 100b via electrical connector 110b. Second bus connector 100b can modulate the received data as a second optical signal and provide the second optical signal to the first bus connector 100a via second fiber-optic segment 120b. Second bus connector 100b can provide the second optical signal to electro-optical transceiver 140 via first fiber-optic segment 120a.

Electro-optical transceiver 140 can include an electrical-to-optical transceiver that can provide optical signals to and receive optical signals from the network of bus connectors 100. Electro-optical transceiver 140 can further include or be connected to signal processing circuitry 142. In these and other embodiments of the present invention, some of the processing that would typically be performed by electro-optical transceiver 140 can be moved to some or all of the various bus connectors 100. This can help to simplify electro-optical transceiver 140. This can also provide a system where different sets or configurations of wireless standards can be supported in an electronic device without having to redesign or change the electro-optical transceiver 140 for each configuration.

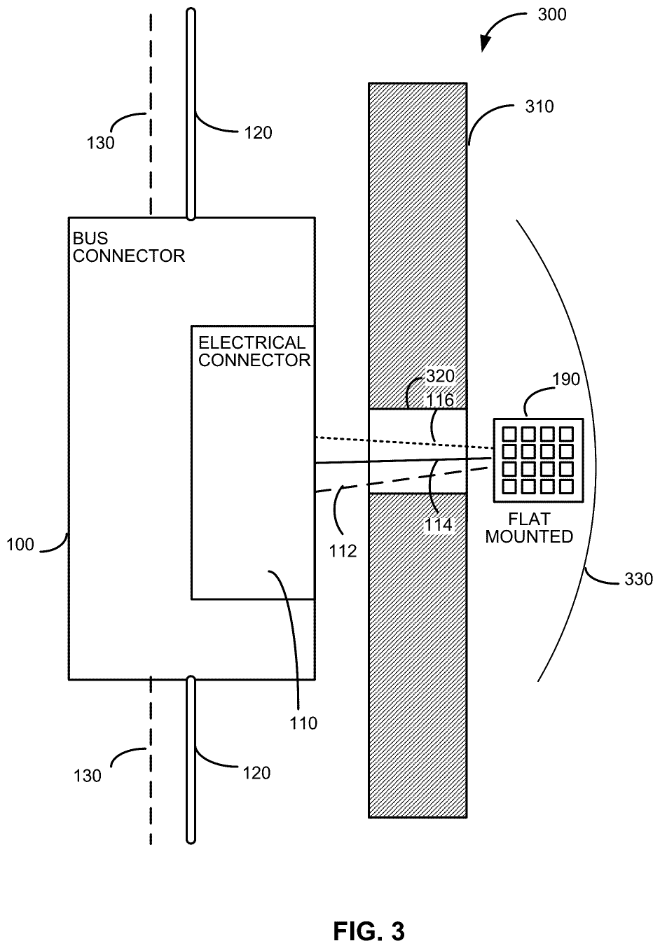

As an example, an electronic device 300 (shown in FIG. 3) can support Wi-Fi, Bluetooth, and LTE using a star topology. If millimeter wave communications were added, two or more two sets of components 190 for millimeter wave communications might need to be added to avoid blocking by a user manipulating electronic device 300. Each of these sets would require electro-optical transceiver 140 to include an additional interface and support circuitry. In contrast, embodiments of the present invention can add two or more two sets of components for millimeter wave communications by adding two bus connectors 100 and corresponding fiber-optic segments 120. Further, when bus connectors 100 are suitably sophisticated, no change to electro-optical transceiver 140 might be needed to support millimeter wave communications. Short of this, bus connectors 100 can include functionality that can simplify electro-optical transceiver 140 and any modifications that might need to be made to electro-optical transceiver 140.

Electro-optical transceiver 140 can also provide control signals to one or more bus connectors 100 on line 130. These control signals can provide configuration information, they can enable or disable a bus connector 100, they can adjust the optical frequency ranges used by add and drop circuits in the bus connectors, as well as other configuration, control, and measurement functions. Line 130 can further be used to distribute power to one or more bus connectors 100.

In this example, each bus connector 100 is coupled between two other bus connectors 100, between another bus connector 100 and electro-optical transceiver 140, or between another bus connector 100 and terminator 105. In these and other embodiments of the present invention, each bus connector can be connected to a cascaded bus, ring, or daisy-chain.

The fiber-optic segments 120 can be short, on the scale of less than one-to-several centimeters. As a result, simple, lower-quality fiber-optic cabling can be used, thereby saving resources. Alternatively, higher-quality fiber-optic cabling can be used, for example where fiber-optic segments 120 are lower or reduced losses are desired. Given the wide bandwidth of fiber-optic cables, embodiments of the present invention can support multiple data signals for transmission, multiple received data signals, and multiple control signals. These signals can be analog or digital signals or a combination thereof. An example is shown in the following figure.

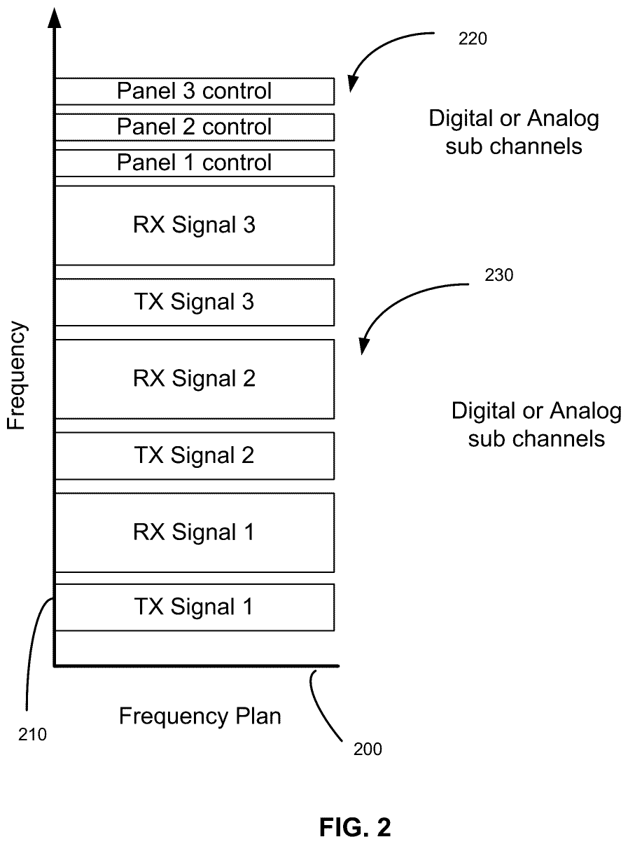

FIG. 2 illustrates a frequency map according to an embodiment of the present invention. This frequency map 200 can ensure that the frequency of optical signals do not interfere with each other. This frequency map 200 can be configurable and the assigned frequencies can change based on which bus connectors 100 and corresponding wireless components 190 are active at a given time. As shown below, add and drop functions can be used to provide a separation between and among frequencies conveyed through the network of bus connectors 100.

Frequency map 200 is shown as a function of frequency 210. Control signals can be carried on digital or analog subchannels 220, while transmitted and received data can be carried on digital or analog subchannels 230. For example, signals transmitted using a first bus connector 100a (shown in FIG. 1) can be conveyed as optical signals in the range shown as TX Signal 1, while signals received using a first bus connector 100a can be conveyed as optical signals in the range shown as RX Signal 1 in digital or analog subchannels 230. Control signals for first bus connector 100a and components 190a (shown in FIG. 1) can be conveyed as Panel 1 control in digital or analog subchannels 220. The relative positioning and sizes of the frequency ranges are shown for illustrative purposes.

A bus connector 100 can connect to one or more components 190 (both shown in FIG. 1) for a wireless protocol in various ways. For example, bus connector 100 can have an electrical connector 110 that can provide and receive analog signals and digital signals. The electrical connector 110 can further provide power to components 190. The components 190 can be located inside electronic device 300 (shown in FIG. 3), the components 190 can be external to electronic device 300, or some can be located inside while others are located outside. An enclosure 310 (shown in FIG. 3) for electronic device 300 can include one or more holes or openings 320 (shown in FIG. 3) for some or all of the analog signals, digital signals, and power supplies for and from components 190 placed outside. The outside components 190 can be coated or covered with a protective material 330. The protective material 330 can be radio-frequency transparent. An example is shown in the following figure.

FIG. 3 illustrates a portion of an electronic device according to an embodiment of the present invention. Bus connector 100 can be located in electronic device 300 inside of housing or enclosure 310. Bus connector 100 can receive optical signals from electro-optical transceiver 140 and other bus connectors 100 using fiber-optic segments 120. Bus connector 100 can receive control, configuration, power, and other signals from electro-optical transceiver 140 (shown in FIG. 1) and other circuits and power supplies (not shown) using wired conductors such as line 130. Bus connector 100 can communicate with components 190 using digital signal line 112, analog signal line 114, and power supply line 116. Other lines, such as fiber-optic lines (not shown) can be used. Bus connector 100 can provide signals to components 190, and components 190 can provide signals to bus connector 100 using some or all of digital signal line 112, analog signal line 114, power supply line 116, and other included lines. Components 190 can be external to housing or enclosure 310 as shown, components 190 can be internal to housing or enclosure 310, or some of components 190 can be internal while others are external. For example, millimeter wave and other elements can be internal and can be positioned to radiate through opening 320 or other cutout in enclosure 310. Digital signal line 112, analog signal line 114, and power supply line 116 can be routed through opening 320 in housing or enclosure 310. The outside components 190 can be coated or covered with a protective material 330. The protective material 330 can be radio-frequency transparent.

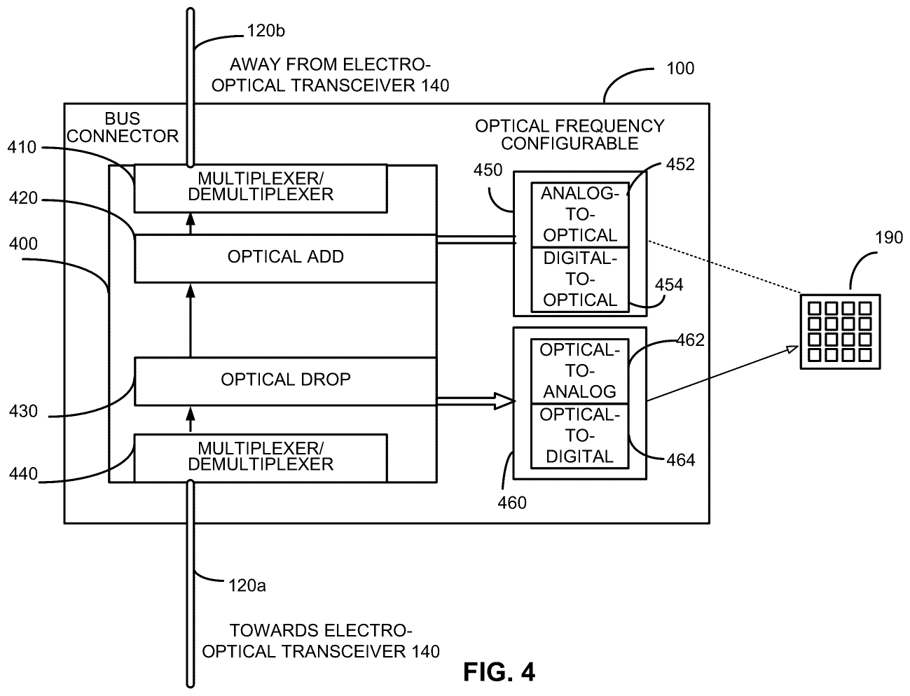

In these and other embodiments of the present invention, bus connectors 100 can include various levels of complexity. For example, a bus connector 100 can include optical add circuits 420 and optical drop circuits 430 (shown in FIG. 4.) An optical add circuit 420 can receive a signal from associated components and provide it to a fiber-optic segment 120 that is connected in the direction towards electro-optical transceiver 140. The added frequency can be positioned in the frequency spectrum such that it does not interfere with other optical signals being provided to or from the electro-optical transceiver 140. An optical drop circuit 430 can receive a signal from electro-optical transceiver 140 over a fiber-optic segment 120 that is connected in the direction towards from the electro-optical transceiver. The dropped frequency can be removed, that is, it might not be provided to the following bus connector 100 in the daisy-chain. The dropped frequency can be provided to components associated with bus connector 100. Examples are shown in the following two figures.

FIG. 4 is a block diagram of a bus connector according to an embodiment of the present invention. Bus connector 100 can receive a first plurality of optical signals from electro-optical transceiver 140 (shown in FIG. 1) on fiber-optic segment 120a. Bus connector 100 can include optical components 400. Optical components 400 can include multiplexer/demultiplexer 440, which can receive the first plurality of optical signals. Optical drop circuit 430 can extract or demultiplex a first optical signal in a first frequency range from the first plurality of optical signals and provide the extracted first optical signal to optical-to-electrical converters 460. Optical-to-electrical converters 460 can include an optical-to-analog converter 462 and an optical-to-digital converter 464. Optical-to-electrical converter 460 can convert the first optical signal to a first electronic signal. That is, optical-to-electrical converter 460 can receive the first optical signal, which can be a data signal modulated at a first frequency and can demodulate the signal to baseband frequencies for transmission over a wired conductor. The first electronic signal can be provided via electrical connector 110 (shown in FIG. 1) to components 190. The first plurality of optical signals less the first optical signal can be provided to multiplexer/demultiplexer 410, which can provide the remaining optical signals to fiber-optic segment 120b.

In these and other embodiments of the present invention, optical components 400 can be implemented as optical phase shifters and other components. Other technologies, such as plasmonic components, can also or instead be used. Such technologies can be used to reduce the volume in a device consumed by optical components 400.

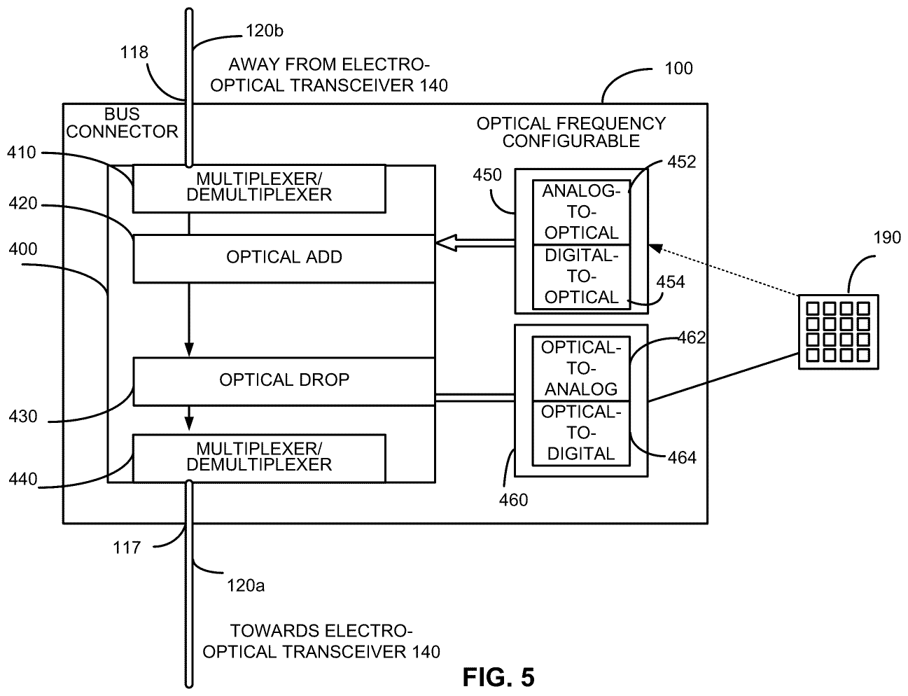

FIG. 5 is a block diagram of a bus connector according to an embodiment of the present invention. Bus connector 100 can receive a second plurality of optical signals from one or more bus connectors 100 on fiber-optic segment 120b. Bus connector 100 can include optical components 400. Optical components 400 can include multiplexer/demultiplexer 410, which can receive the second plurality of optical signals. A second electronic signal can be received via electrical connector 110 (shown in FIG. 1) from components 190. The second electronic signal can be provided to electrical-to-optical converters 450. Electrical-to-optical converter 450 can include an analog-to-optical converter 452 and a digital-to-optical converter 454. Electrical-to-optical converter 450 can convert the second electronic signal to a second optical signal. That is, electrical-to-optical converter 450 can receive the first electrical signal and can convert the first electrical signal to a modulated second optical signal for transmission over a fiber-optic segment 120. Optical add circuit 420 can add or multiplex the second optical signal, which can be positioned in a second frequency range, to the second plurality of optical signals. The second plurality of optical signals, along with the second optical signal, can be provided to multiplexer/demultiplexer 440, which can provide these optical signals to fiber optic-segment 120a.

In these and other embodiments of the present invention, fiber-optic segments 120 can connect to a set of components in various ways. For example, a bus connector 100 can have a first optical port 117 to connect to a first fiber-optic segment 120a and a second optical port 118 to connect to a second fiber-optic segment 120b. The ports can include a fiber-optic receptacle, a tethered connection to a segment of fiber-optic cable, or other type of fiber-optic connection (not shown.) As an example, a bus connector 100 can include a first optical port 117 having a fiber-optic receptacle for accepting a fiber-optic plug and a second optical port 118 having a tethered fiber-optic segment 120b, where the fiber-optic segment 120b terminates in a fiber-optic plug (not shown.) The fiber-optic plug can be plugged into a fiber-optic receptacle of an adjacent or other bus connector 100 to form a portion of a ring or daisy-chain. In another example, a bus connector 100 can include a second optical port 118 having a fiber-optic receptacle for accepting a fiber-optic plug and a first optical port 117 having a tethered fiber-optic segment 120a, where the fiber-optic segment 120a terminates in a fiber-optic plug. The fiber-optic plug can be plugged into a fiber-optic receptacle of an adjacent or other bus connector 100 to form a portion of a ring or daisy-chain. This can result in a highly configurable topology where connectors and corresponding components can be easily added, removed, or swapped. The connectors and corresponding components can be placed around a periphery or elsewhere in an electronic device.

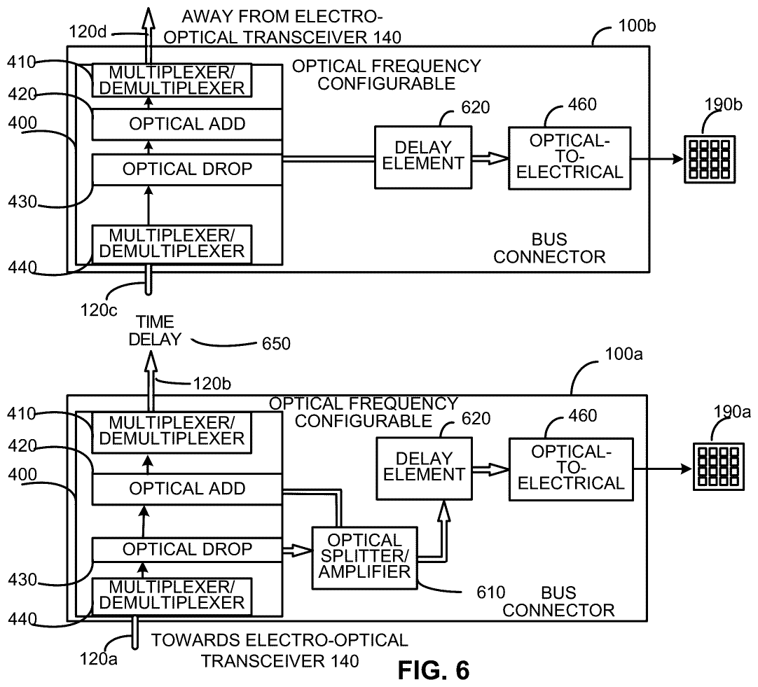

In these and other embodiments of the present invention it can be desirable to provide a dropped signal to one or more following connectors in the daisy chain. For example, data can be transmitted using more than one bus connector 100 and corresponding components 190. To provide this, a signal can be dropped by a first bus connector 100 and added back in by the first bus connector 100 to be provided to a second bus connector 100. When more than one bus connector 100 and transmitter components 190 are used, it can be desirable to phase shift the two transmitted signals relative to each other. Accordingly, a bus connector 100 can include one or more optical delay elements 620 (shown in FIG. 6.) Optical delay elements 620 can further be included in an optical path between connectors, for example between a first bus connector 100 and second bus connector 100. These delays can be set by control circuity in bus connector 100, electro-optical transceiver 140, or elsewhere. This can be particularly useful for beam-forming. An example is shown in the following figure.

FIG. 6 illustrates two bus connectors operating to transmit a signal using two sets of wireless components at different locations in an electronic device. Bus connector 100a can receive a first plurality of optical signals from electro-optical transceiver 140 on fiber-optic segment 120a. Bus connector 100a can include optical components 400. Optical components 400 can include multiplexer/demultiplexer 440, which can receive the first plurality of optical signals. Optical drop circuit 430 can extract or demultiplex a first optical signal in a first frequency range from the first plurality of optical signals and provide the extracted first optical signal to optical splitter and amplifier 610. Optical splitter and amplifier 610 can provide the optical signal to an optical delay element 620, which can provide it to optical-to-electrical converters 460. Optical-to-electrical converters 460 can include an optical-to-analog converter 462 and an optical-to-digital converter 464 (shown in FIG. 4.) Optical-to-electrical converter 460 can convert the first optical signal to a first electronic signal. That is, optical-to-electrical converter 460 can receive the first optical signal, which can be a data signal modulated at a first frequency and can demodulate the signal to baseband frequencies for transmission over a wired conductor. The first electronic signal can be provided via electrical connector 110 (shown in FIG. 1) to components 190. The first plurality of optical signals less the first optical signal can be provided to optical add circuit 420. Optical add circuit 420 can receive the first optical signal from optical splitter and amplifier 610 and provide the first plurality of optical signals to multiplexer/demultiplexer 410, which can provide the first plurality of optical signals to fiber-optic segment 120b.

The first plurality of optical signals at fiber-optic segment 120b can be delayed by time delay 650 and provided to fiber-optic segment 120c. One or more bus connectors 100 can be connected between fiber-optic segment 120b and fiber-optic segment 120c. The first plurality of optical signals can be received by multiplexer/demultiplexer 440 in optical components 400 in bus connector 100b. Optical drop circuit 430 can extract or demultiplex the first optical signal in the first frequency range from the first plurality of optical signals and provide the extracted first optical signal to optical delay element 620, which can provide it to optical-to-electrical converters 460. Optical-to-electrical converter 460 can include an optical-to-analog converter 462 and an optical-to-digital converter 464 (shown in FIG. 4.) Optical-to-electrical converter 460 can convert the first optical signal to a first electronic signal. That is, optical-to-electrical converter 460 can receive the first optical signal, which can be a data signal modulated at a first frequency and can demodulate the signal to baseband frequencies for transmission over a wired conductor. The first electronic signal can be provided via electrical connector 110 (shown in FIG. 1) to components 190b. The first plurality of optical signals less the first optical signal can be provided to multiplexer/demultiplexer 410, which can provide the first plurality of optical signals less the first optical signal to fiber-optic segment 120d. In this way, the first signal can be transmitted using both components 190a and components 190b. Components 190a and components 190b can be placed at different locations.

In these and other embodiments of the present invention, it can be desirable to combine two or more received signals. For example, a first bus connector can be used to receive a first signal. A second bus connector can remove the first signal. The second bus connector can receive a second signal and add it to the first signal. The combined signal can be provided as an optical signal over a fiber-optic signal towards the electro-optical transceiver. Instead of combining the first signal and the second signal in the second bus connector, the first signal and the second signal can be provided to the electro-optical transceiver for combining and further processing.

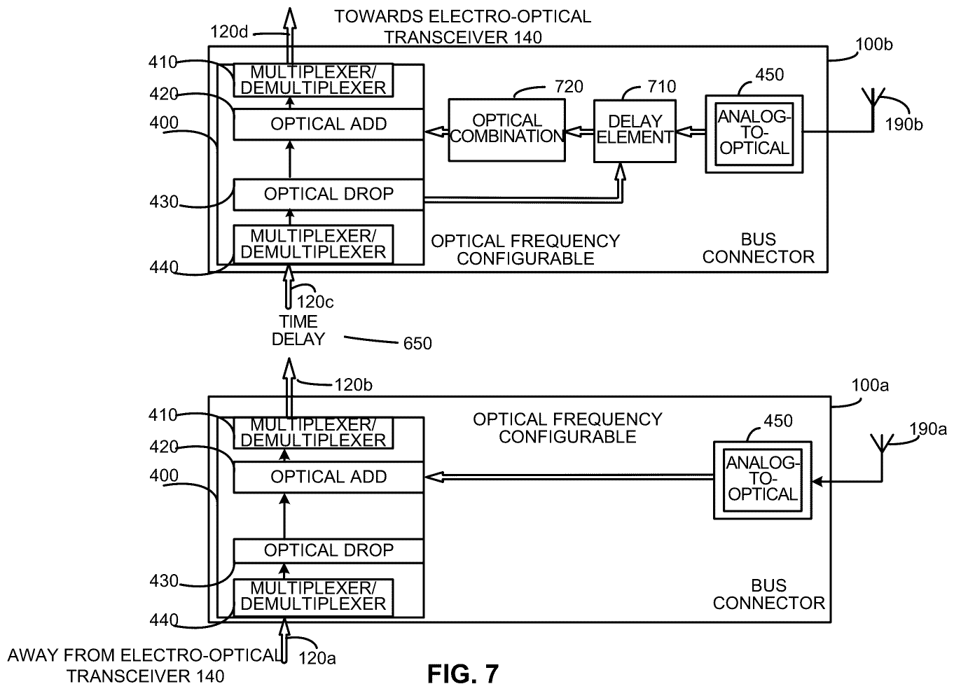

FIG. 7 illustrates two bus connectors operating to combine two signals received at different locations in an electronic device. Bus connector 100a can receive a second plurality of optical signals from one or more bus connectors 100 on fiber-optic segment 120a. Bus connector 100a can include optical components 400. Optical components 400 can include multiplexer/demultiplexer 440, which can receive the second plurality of optical signals. A first electronic signal can be received via electrical connector 110 (shown in FIG. 1) from components 190a. The first electronic signal can be provided to electrical-to-optical converters 450. Electrical-to-optical converter 450 can include an analog-to-optical converter 452 and a digital-to-optical converter 454 (shown in FIG. 5.) Electrical-to-optical converter 450 can convert the first electronic signal to a first optical signal. That is, electrical-to-optical converter 450 can receive the first electrical signal and can modulate and convert it to a first optical signal for transmission over a fiber-optic segment 120b. Optical add circuit 420 can add or multiplex the first optical signal, which can be positioned in a first frequency range, to the second plurality of optical signals. The second plurality of optical signals, along with the second optical signal, can be provided to multiplexer/demultiplexer 410, which can provide the remaining optical signals to fiber-optic segment 120b.

The second plurality of optical signals at fiber-optic segment 120b can be delayed by time delay 730 and provided to fiber-optic segment 120c. One or more bus connectors 100 can be connected between fiber-optic segment 120b and fiber-optic segment 120c. The first plurality of optical signals can be received by multiplexer/demultiplexer 440 in optical components 400 in bus connector 100b. Optical drop circuit 430 can remove or demultiplex the first optical signal and provide it to delay element 710. A second electronic signal can be received via electrical connector 110 (shown in FIG. 1) from components 190b. The second electronic signal can be provided to electrical-to-optical converters 450. Electrical-to-optical converter 450 can convert the second electronic signal to a second optical signal and provide the second optical signal to delay element 710. Delay element 710 can provide the first optical signal and the second optical signal to optical combiner 720, which can add the first optical signal and the second optical signal. The sum can be provided to optical add circuit 420, which can provide it to electro-optical transceiver 140 via fiber-optic segment 120d.

These add, drop, split, and combine functions can be further extended. For example, optical signal components at multiple frequencies can be dropped from the fiber-optical cabling by a bus connector. Two or more of these multiple frequencies can be combined and forwarded to the electro-optical transceiver or another bus connector. One or more of these various frequencies can be delayed. These delays can be computed by circuitry in one or more connectors to further reduce workload on the electro-optical transceiver.

Control signals can be handled in various ways in these and other embodiments of the present invention. For example, control signals can be added and dropped from the fiber-optic cable segments by a bus connector. The control signals can be conveyed on one or more separate wired connections that are routed along with or near the fiber-optic cable segments. Both optical and wired control signals can be used. These control signals can be processed in the bus connector to reduce the workload of the electro-optical transceiver. These control signals can be used in configuring or reconfiguring the connectors and associated components, disabling blocked receivers or transmitters, for entering low-power states, and for other purposes. These control signals can be used in allocating various processing tasks among the electro-optical transceiver and circuitry in the bus connectors. The control signals can control the various processing tasks such as protocol translation and pre and post processing of control and measurement data received by the bus connector. The control signals can be used to set an initial state or an updated state.

Some control signals for start-up and other times can be provided using wired conductors. This can allow the configuration of the bus connectors without having to use the optical bus. When the optical bus is used for configuration, an initial configuration can be set using nonvolatile memory, fuses, or other mechanisms.

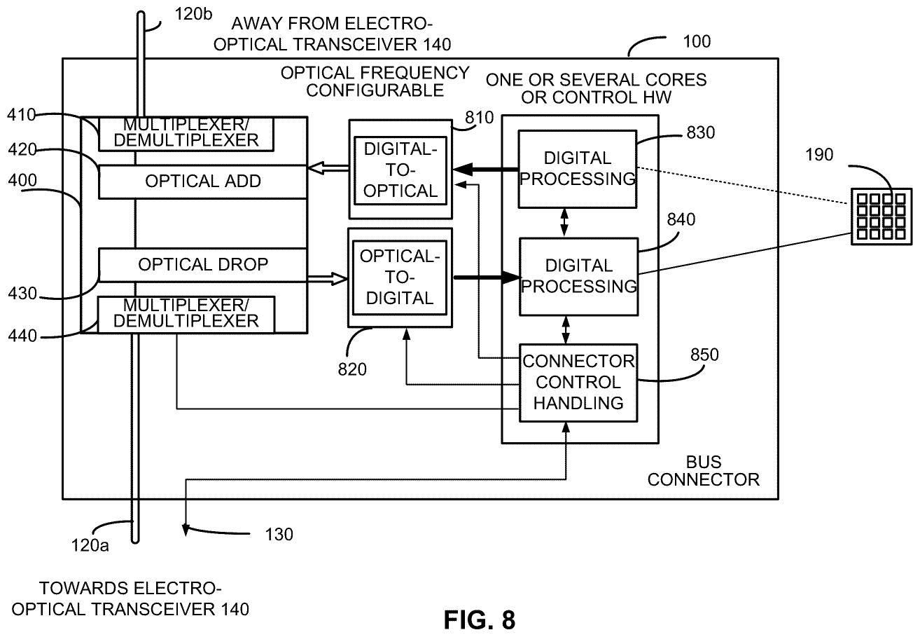

FIG. 8 control signal routing and processing for a bus connector according to an embodiment of the present invention. In this example, control data, configuration data, measurement data, and other signals, or more simply control data, can be provided to bus connector 100 over fiber-optic segment 120a, fiber-optic segment 120b, or wired conductor line 130. Control data can be received by bus connector 100 from electro-optical transceiver 140 (shown in FIG. 1), other bus connectors 100, or other sources over fiber-optic segment 120a. Control data can also be received from other bus connectors 100 or other sources over fiber-optic segment 120b. The control data can be modulated by electro-optical transceiver 140 or other circuit to a frequency of one of the digital or analog subchannels 220 (shown in FIG. 2.) The control data can be extracted or demodulated and converted to an electrical signal by optical drop circuit 430 and provided to optical-to-digital converter 820. The demodulated control data can then be provided to digital processing circuit 840. Outputs from digital processing circuit 840 can be provided to components 190.

Control data, such as received-signal-strength indicator (RSSI) or other measurement data can be generated by components 190. This data can be provided to digital processing circuit 830. The output of digital processing circuit 830 can be converted to an optical signal and modulated to a frequency of one of the digital or analog subchannels 220 by digital-to-optical converter 810. The optical control data can then be added by optical add circuit 420 and provided to electro-optical transceiver 140, other bus connectors 100, or other circuits.

These control signals can be used in allocating various processing tasks among electro-optical transceiver 140 and circuitry in bus connectors 100. The control signals can control the various processing tasks such as protocol translation and pre and post processing of control and measurement data received by bus connector 100. The control signals can be used to set an initial state or an updated state. The control signals can be used to set delays in delay elements and to determine the frequencies of the various optical signals. The frequency of the optical signals can be set by electro-optical transceiver 140, by bus connector 100, by multiple bus connectors 100, by other circuits, or by a combination of some or all of these circuits.

Control signals can also be received and provided on line 130 by connector control handling circuit 850. Connector control handling circuit 850 can configure the frequencies for the optical data received and transmitted by bus connector 100 by adjusting parameters of the digital-to-optical converter 810 and optical-to-digital converter 820. Connector control handling circuit 850 can further program and configure digital processing circuit 830 and digital processing circuit 840.

A transmitter or receiver can be blocked, for example by a user's hand while holding an electronic device. Corresponding components can be used to detect such a blockage. The corresponding components can send a signal to the baseband to disable the corresponding connector to save power. A control module in the bus connector can also or instead detect blockage. The control module can then turn off the bus connector and inform the electro-optical transceiver. The electro-optical transceiver can turn off some wireless circuits and turn on other wireless circuits in response to a detected blockage. For example, components that are not blocked can be turned on to replace the blocked components.

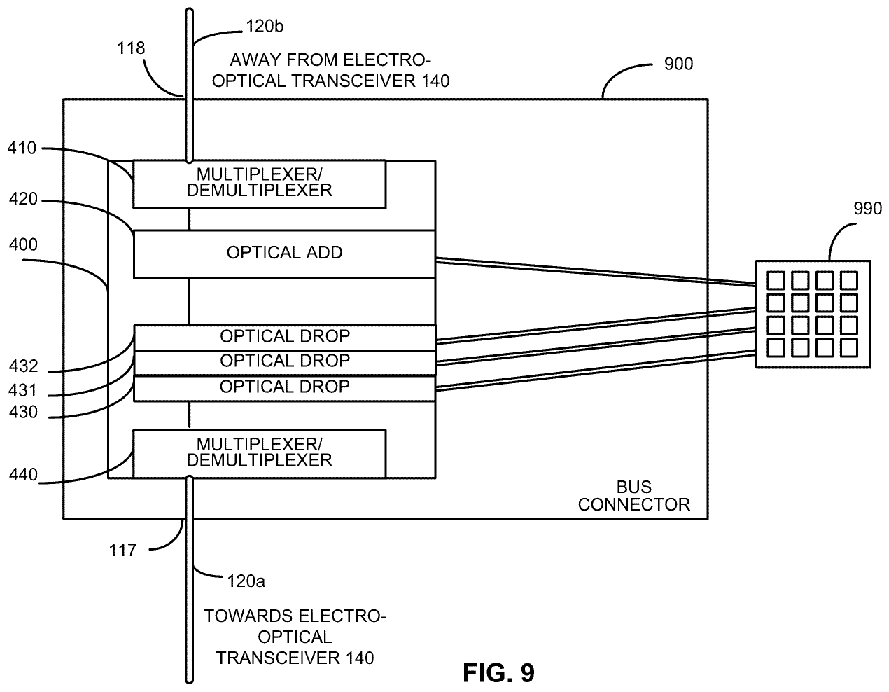

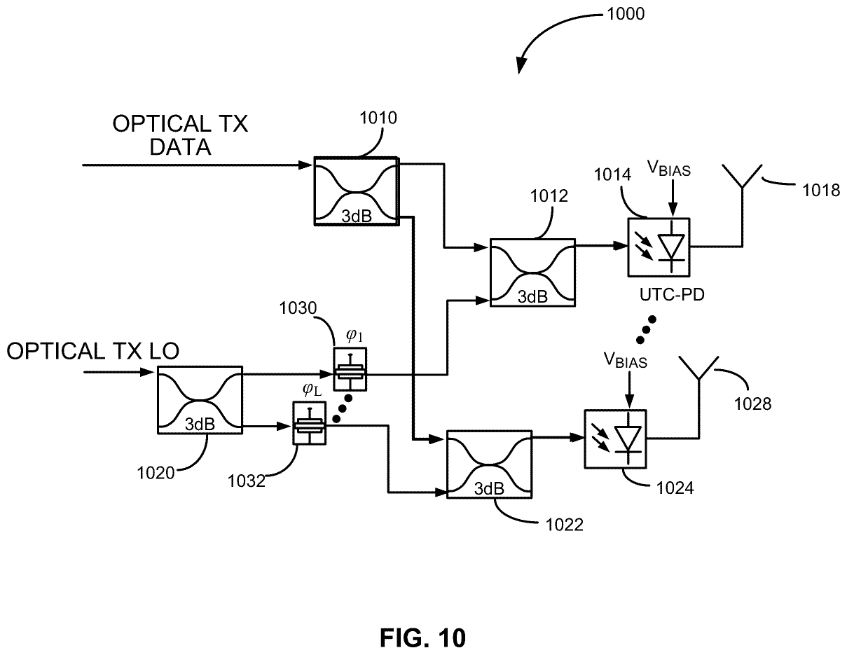

FIG. 9 illustrates a bus connector according to an embodiment of the present invention. Data can be wirelessly transmitted by bus connector 900 using a data modulated optical transmit carrier and an unmodulated optical transmit carrier, which can be used for generating an antenna array response. The data modulated optical transmit carrier can be received by optical drop circuit 430 and provided to components 990, while the unmodulated optical transmit carrier can be received by optical drop circuit 431 and provided to components 990. The unmodulated optical transmit carrier can be subtracted from the modulated optical transmit carrier by components 990 to generate an RF signal for transmission, as shown below in FIG. 10.

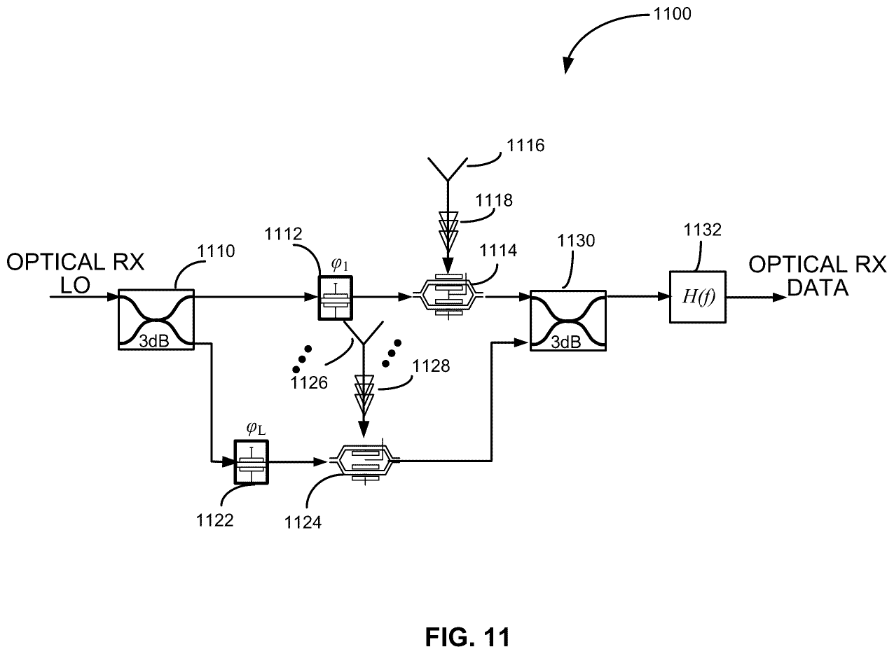

An unmodulated optical receive carrier can be received by optical drop circuit 432 and provided to components 990. A received RF signal can modulate the unmodulated optical receive carrier to generate a data modulated optical receive carrier. The data modulated optical receive carrier can be provided to optical add circuit 420, as shown below in FIG. 11. In this way, optical data received by the bus connector 900 from components 990 can be added to the optical signals transmitted by bus connector 900 and provided to electro-optical transceiver 140 or other bus connectors in network 10 (shown in FIG. 1) via first optical port 117 or second optical port 118.

Components 990 can be located inside housing or enclosure 310 (shown in FIG. 3) or on an outside surface of enclosure 310. Components 990 can be inside enclosure 310 and placed near opening 320 (shown in FIG. 3) or other opening or slot in enclosure 310 such that wireless signals can be transmitted and received. Components 990 can be located on an outside surface of enclosure 310 and the optical signals can be provided through opening 320. Bus connector 900 can be the same as or similar to bus connector 100, or bus connector 900 can be different than bus connector 100. For example, bus connector 900 can be simplified as compared to bus connector 100. Bus connector 900 can be similar to bus connector 100 with an absence of electrical-to-optical converters 450 and optical-to-electrical converters 460.

FIG. 10 illustrates a transmit path that can be used to transmit signals by a bus connector according to an embodiment of the present invention. Transmit path 1000 can be implemented as a portion of components 990 (shown in FIG. 9.) A data modulated optical transmit carrier, OPTICAL TX DATA, and a phase shifted unmodulated optical transmit carrier (a local oscillator signal), OPTICAL TX LO, can be combined. The combined signal can illuminate a high-efficiency photodiode, such as a uni-traveling-carrier photodiode (UTC-PD), in a process referred to as heterodyning. The non-linear response of the UTC-PD can generate the wanted RF frequency ƒRF=ƒ_{data}−ƒLO, where ƒ_{data} is the frequency of the data modulated optical transmit carrier OPTICAL TX DATA and ƒLO is the frequency of the unmodulated optical transmit carrier OPTICAL TX LO.

The photodiodes 1014 and 1024, phase shifters 1030 and 1032, and part of the optical distribution network can be colocated to the antenna array elements 1018 and 1028. Phase shifters 1030 and 1032 can be implemented in optical or plasmonic technology. Two optical drops for two optical carriers (one modulated and one unmodulated) can be used to generate data for transmission. Additional control circuitry, such as that shown in FIG. 8, is not shown here for simplicity.

This example is described as having two photodiode paths, though three or more such paths can be included. The data modulated optical transmit carrier, OPTICAL TX DATA, can be received by optical drop circuit 430 (shown in FIG. 9) and provided to splitter 1010. Splitter 1010 can provide outputs to splitter 1012 and splitter 1022. The unmodulated optical transmit carrier, OPTICAL TX LO, can be received by optical drop circuit 431 (shown in FIG. 9) and provided to splitter 1020. Splitter 1020 can provide outputs to phase shifter 1030 and phase shifter 1032. The output of phase shifter 1030 can be provided to splitter 1012, which can provide an output to UTC-PD 1014. UTC-PD 1014 can drive antenna array elements 1018. The output of phase shifter 1032 can be provided to splitter 1022, which can provide an output to PD 1024. PD 1024 can drive antenna array elements 1028.

FIG. 11 illustrates a receive path that can be used to receive signals by a bus connector according to an embodiment of the present invention. Receive path 1100 can be implemented as a portion of components 990 (shown in FIG. 9.) This receiver can employ one unmodulated optical receive carrier (or local oscillator signal), OPTICAL RX LO, for the upconversion. The unmodulated optical receive carrier can be split into as many antenna elements to apply individual optical phase shifts to generate an antenna array response. The individually phase shifted unmodulated optical receive carriers can be modulated with the received and amplified RF signal to up-convert to an optical frequency ƒ_{optical}=ƒRF+ƒLO, where ƒRF is the frequency of the received radio frequency (RF) signal and ƒLO is the frequency of the unmodulated optical receive carrier. Up-conversion of the signal can be performed via a Mach-Zehnder Modulator (MZM), which can be implemented in optical or plasmonic technology. Amplifiers, phase shifters, MZMs and part of the optical distribution network can be collocated with antenna elements.

This example is described as having two MZM paths, though three or more such paths can be included. The unmodulated optical receive carrier, OPTICAL RX LO, can be received by optical drop circuit 432 (shown in FIG. 9) and provided to splitter 1110. Splitter 1110 can provide outputs to phase shifter 1112 and phase shifter 1122. Phase shifter 1112 can provide an output to optical modulator 1114, which can be an MZM. Phase shifter 1122 can provide an output to optical modulator 1124, which can also be an MZM. An RF signal can be received by antenna array 1116 and can drive the RF input of optical modulator 1114 via low-noise amplifiers 1118. The RF signal can be received by antenna array 1126 and can drive the RF input of optical modulator 1124 via low-noise amplifiers 1128. The outputs of optical modulator 1114 and optical modulator 1124 can be combined by splitter 1130, filtered by filter 1132, and provided as a data modulated optical receive carrier, OPTICAL RX DATA. The data modulated optical receive carrier, OPTICAL RX DATA, can be provided to optical add circuit 420 (shown in FIG. 9.)

In these and other embodiments of the present invention, the bus connectors and their associated components can be positioned in the daisy-chain in various ways. For example, bus connectors and components that handle very-high frequency signaling can be positioned closer to the electro-optical transceiver. This can allow the use of lower-speed bus connectors later in the daisy-chain, which can help to conserve resources.

In these and other embodiment of the present invention, unused bus connectors 100 can be included to provide for potential upgrades. An unused bus connector 100 that is not connected to associated components can be optically transparent and can repeat optical signals in each direction without processing.

In these and other embodiments of the present invention, different numbers of daisy-chained bus connectors 100 and electro-optical transceivers 140 can be used. For example, one electro-optical transceiver 140 can connect to two, three, or more than three daisy-chains.

The daisy-chain or ring topology employed by embodiments of the present invention can be modified in various ways. For example, a segment of fiber-optic cable can be split and a bus connector can be attached to each split of the segment. Other conductors, such as one or more wire conductors for conveying power, control signals, or other power supplies, bias lines, or signals, can be routed adjacent to or along with the fiber-optic cabling. For example, a disable signal that removes power from a blocked (for example by a user's hand) millimeter wave communications circuit and corresponding bus connector can be included.

Embodiments of the present invention can provide routing and bus connectors for wireless interfaces that can be located in various types of devices, such as portable computing devices, tablet computers, desktop computers, laptops, all-in-one computers, wearable computing devices, smart or cell phones, storage devices, portable media players, navigation systems, monitors, power supplies, adapters, remote control devices, chargers, and other devices.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

1. A bus connector comprising:
a first optical port to receive a first plurality of optical signals;
a second optical port;
an optical multiplexer/demultiplexer coupled between the first optical port and the second optical port;
a first optical drop circuit to remove a first optical signal from the first plurality of optical signals and to provide the first optical signal;
an optical-to-electrical converter to convert the first optical signal provided by the first optical drop circuit to a first electrical signal; and
an electrical connector to provide the first electrical signal.

2. The bus connector of claim 1 wherein the first optical port is further configured to transmit optical signals, and wherein the electrical connector further receives a second electrical signal, the bus connector further comprising:
an electrical-to-optical converter to convert the second electrical signal to a second optical signal; and
a first optical add circuit to receive the second optical signal and add the second optical signal to the first plurality of optical signals.

3. The bus connector of claim 2 further comprising a tethered fiber-optic segment connected at a first end to one of the first optical port and second optical port and an optical plug at a second end of the tethered fiber-optic segment, the second end opposite the first end.

4. (canceled)

5. The bus connector of claim 3 further comprising a receptacle at the other of the first optical port and second optical port.

6. The bus connector of claim 2 wherein the first optical signal is removed from the first plurality of optical signals by optically demultiplexing a first range of frequencies and the second optical signal is added to the first plurality of optical signals by multiplexing a second range of frequencies, and wherein the first range of frequencies and the second range of frequencies are configurable.

7. The bus connector of claim 6 wherein the optical-to-electrical converter comprises an analog optical-to-electrical converter and a digital optical-to-electrical converter, and the electrical-to-optical converter comprises an analog electrical-to-optical converter and a digital electrical-to-optical converter.

8. The bus connector of claim 1 wherein a component used in the first optical drop circuit comprises a plasmonic component.

9. A network of wireless circuits comprising:
a plurality of bus connectors, at least one of the bus connectors comprising the bus connector of claim 1;
a plurality of fiber-optic segments each coupled between a first optical port and a second optical port of two of the plurality of bus connectors to form a daisy chain; and
a plurality of sets of wireless components, each set of wireless components connected to the electrical connector of a corresponding bus connector.

10. The network of claim 9 wherein each bus connector further comprises a multiplexer/demultiplexer circuit coupled between the first optical port and the second optical port.

11. The network of claim 10 wherein each bus connector further comprises a fiber-optic receptacle coupled to one of the first optical port and second optical port, and wherein the other of the first optical port and second optical port is tethered to one of the plurality of fiber-optic segments.

12. (canceled)

13. (canceled)

14. The network of claim 10 wherein each bus converter further comprises an optical drop circuit and an optical add circuit coupled to the multiplexer/demultiplexer circuit.

15. The network of claim 9 further comprising a cascaded bus, ring, or daisy chain coupled to a first bus connector in the plurality of bus connectors.

16. An electronic device comprising:
an enclosure at least partially housing the electronic device;
a plurality of bus connectors, each positioned in the enclosure;
a plurality of fiber-optic segments each coupled between a first optical port and a second optical port of two of the plurality of bus connectors;
a plurality of sets of wireless components, each set of wireless components connected to an electrical connector of a corresponding bus connector; and
an electro-optical transceiver coupled to a first one of the plurality of bus connectors through a first one of the plurality of fiber-optic segments.

17. The electronic device of claim 16 wherein each bus connector further comprises a multiplexer/demultiplexer circuit coupled between the first optical port and the second optical port.

18. The electronic device of claim 16 wherein each bus connector further comprises a first multiplexer/demultiplexer circuit coupled to the first optical port, a second multiplexer/demultiplexer circuit coupled to the second optical port, and an optical add drop circuit coupled between the first multiplexer/demultiplexer circuit and the second multiplexer/demultiplexer circuit.

19. The electronic device of claim 16 wherein each bus connector further comprises:
an optical-to-electrical converter to convert a first optical signal received by the bus connector to first electrical signal; and
an electrical-to-optical converter to convert a second electrical signal to a second optical signal to be transmitted by the bus connector.

20. The electronic device of claim 19 wherein each bus connector further comprises an electrical connector to provide the first electrical signal and to receive the second electrical signal.

21. The electronic device of claim 16 wherein the electro-optical transceiver is further coupled to a second one of the plurality of bus connectors through a second one of the plurality of fiber-optic segments.

22. A bus connector comprising:
a first optical port to receive a first plurality of optical signals;
a second optical port;
an optical multiplexer/demultiplexer coupled between the first optical port and the second optical port;
a first optical drop circuit to remove an unmodulated optical transmit carrier from the first plurality of optical signals and to provide the unmodulated optical transmit carrier to a first plurality of components;
a second optical drop circuit to remove a data modulated optical transmit carrier from the first plurality of optical signals and to provide the data modulated optical transmit carrier to the first plurality of components;
a third optical drop circuit to remove an unmodulated optical receive carrier from the first plurality of optical signals and to provide the unmodulated optical receive carrier to the first plurality of components; and
an optical add circuit to receive a data modulated optical receive carrier from the first plurality of components and to add the data modulated optical receive carrier to the first plurality of optical signals.

23. The bus connector of claim 22 wherein the first plurality of components comprises a transmit path and a receive path, where the transmit path comprises a heterodyne circuit and the receive path comprises an optical modulator.
